(19) United States
(12) Patent Application Publication
(10) Pub. No.: US 2021/0021177 A1
(43) Pub. Date: Jan. 21, 2021

(54) ENGINE CRANKSHAFT POSITION SENSOR

(71) Applicant: Syncro Corporation, Arab, AL (US)

(72) Inventors: James D. Abel, Sr., Arab, AL (US); Roger Allcorn, Arab, AL (US)

(21) Appl. No.: 16/513,394

(22) Filed: Jul. 16, 2019

(51) Int. Cl. H02K 11/215; H02K 7/02; H02K 7/075; H02K 7/18; H02K 11/04; H02K 15/16; G01M 15/06; F02D 41/34

(52) U.S. Cl. CPC H02K 11/215; H02K 7/02; H02K 7/075; H02K 7/1815; B60W 2510/0685; H02K 15/165; G01M 15/06; F02D 41/34; H02K 11/046

(57) ABSTRACT

An alternator assembly includes a crankshaft that is rotatable about an axis. A rotor is coupled with the crankshaft and is rotatable about the axis in conjunction with the crankshaft. A plurality of magnetic segments is disposed circumferentially about the rotor. Each of the plurality of magnetic segments includes one or more portions having one of a north or south polarity and at least one of the portions on one of the plurality of magnetic segments is configured as a datum section. The datum section has varied characteristic from the remaining one or more portions of the plurality of magnetic segments. A stator includes a plurality of stator poles that includes first and second groups of poles each having respective windings on each pole. The first and second groups are separated by a pair blank poles. A Hall Effect sensor extends between and is supported by the blank poles.

### BACKGROUND

### Field of the Disclosure

The present invention relates to an alternator assembly.

### Description of the Background of the Disclosure

Internal combustion engines of the type generally used for powering lawn mowers, pumps, generators, outboard motors, automotive engines and the like can utilize an alternator assembly that generates electrical current. The alternator may have a rotor that can be coupled with a flywheel. The flywheel/rotor are rotatably coupled with a crankshaft. Electrical current may be generated by the rotation of the flywheel/rotor in close proximity to a stator. The electrical current may be used to charge a battery and/or supply electrical energy for various electronics that are connected with the combustion engine.

For example, in some instances, an electronically-controlled fuel injection system which is adapted for use in small-sized engines may not be equipped with a battery, and thus, may utilize power generated from the alternator assembly to power various electrical components. The electrically powered components may include a control unit for controlling a time period over which fuel injection valves are opened in accordance with operating conditions of the engine. However, such systems regularly fail to inject fuel at proper times, thereby producing excessive emissions. Moreover, as the revolutions per minute (RPM) of the crankshaft is increased, the accuracy at which commercially available crankshaft position measuring sensor assemblies degrades dramatically.

In addition, various sensors can be mounted within a stator pole of the stator. However, as more power is pulled from stator windings disposed around the poles of the stator, the flux density available for the sensor will diminish until unreliable switching occurs. Therefore, what is needed is an alternator assembly that is configured to detect a position of the crankshaft that may be used with various small engines, possibly with higher degrees of precision.

### SUMMARY

In some aspects, an alternator assembly includes a crankshaft that is rotatable about an axis. A rotor is coupled with the crankshaft and is rotatable about the axis in conjunction with the crankshaft. The rotor defines a hub and a cylindrical shell extending outwardly from one end of the hub. A plurality of magnetic segments is disposed circumferentially about an interior surface of the shell. Each of the plurality of magnetic segments includes one or more portions having one of a north or south polarity and at least one of the portions on one of the plurality of magnetic segments configured as a datum section. The datum section has a varied characteristic from the remaining one or more portions of the plurality of magnetic segments. A stator is separated from the rotor by a gap and includes a plurality of stator poles. The plurality of stator poles includes first and second groups of poles each having respective windings on each pole within the first and second group. The first and second groups are separated by a pair of blank poles. A Hall Effect sensor extends between and is supported by the blank poles. The Hall Effect sensor is configured to generate signals based on the magnitude and polarity of magnetic flux generated by each portion of the plurality of magnetic segments.

In some aspects, an alternator assembly includes a rotor rotatably coupled with a crankshaft about a common axis. A first magnetic segment is positioned on the rotor and includes at least a first portion and a datum section separated from the first portion. The first portion has one of a north or south polarity, and the datum section has at least one varied characteristic from the first portion. A stator is separated from the rotor by a gap and includes a plurality of stator poles. The plurality of stator poles include first and second poles each having respective windings thereabout. The first and second stator poles separated by a pair blank stator poles. A Hall Effect sensor extends between and is supported by the blank poles. The Hall Effect sensor is configured to generate signals based on the polarity of magnetic flux generated by at least one of the first portion and the datum section.

In some aspects, a method of manufacturing an alternator assembly includes forming a rotor having a hub and a shell. The method also includes assembling one or more non-magnetized segments to the rotor. The method further includes determining a plurality of magnetization orientation directions of the non-magnetized magnet portions and a varied characteristic for a datum section. In addition, the method includes positioning the rotor within a magnetizing fixture and aligning magnetization directions of the magnet portions with the calculated direction of flux from the magnetizing fixture. The datum section is aligned with a datum portion of the magnetizing fixture. Lastly, the method includes energizing the magnetizing coils using a power source.

### DESCRIPTION OF THE DRAWINGS

FIG. 1 is an exploded front perspective view of a stator, a rotor, and a crankshaft that rotates the rotor relative the stator, according to some embodiments;

FIG. 2 is a schematic diagram showing various components of an internal combustion engine and a control system for operating the engine, according to some embodiments;

FIG. 3 is a rear plan view of the rotor/flywheel disposed over the stator, according to some embodiments;

FIG. 4 is a flux waveform signal generated by a position sensor on the stator when the rotor rotates relative thereto and upper and lower switching thresholds, according to some embodiments;

FIG. 5 is a voltage waveform illustrating operation of the alternator assembly as measured by the position sensor, according to some embodiments; and

FIG. 6 illustrates a method of assembling the alternator assembly, according to some embodiments.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to the embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

Unless specified or limited otherwise, the terms “mounted,” “connected,” “supported,” “coupled,” and the like are used broadly and encompass both direct and indirect mountings, connections, supports, couplings, and so on. Further, “connected” and “coupled” and the like are not restricted to physical or mechanical connections or couplings.

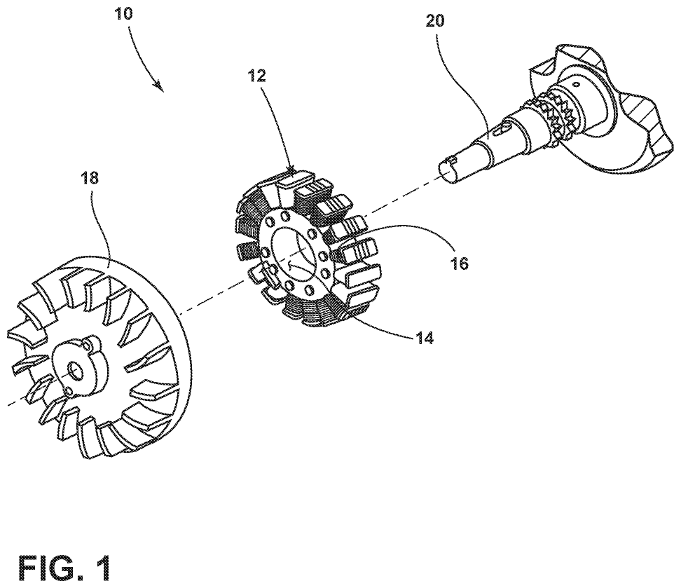

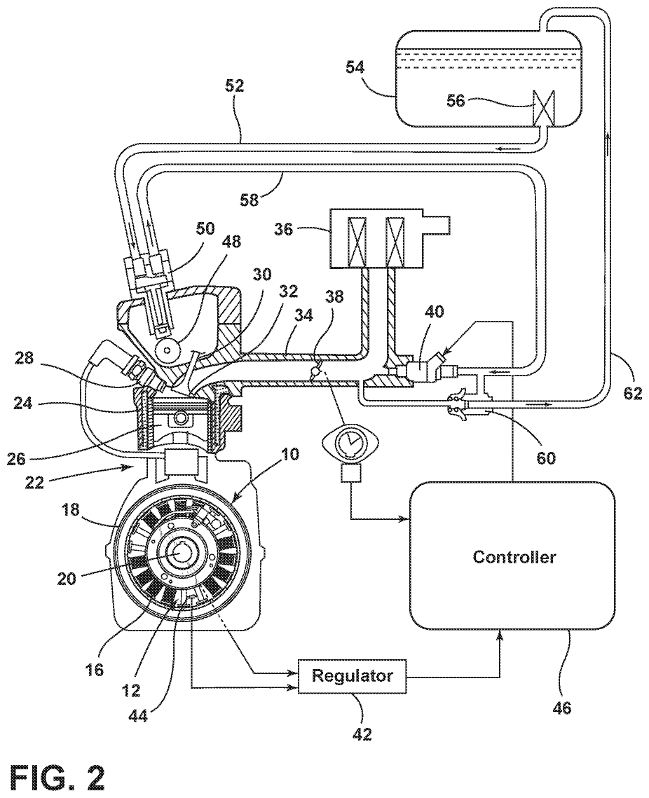

Referring to FIGS. 1 and 2, an alternator assembly 10 of the present disclosure can be coupled with an internal combustion engine 22 and incorporated into a plurality of different power equipment or vehicles, such as lawn mowers, ATVs, snowmobiles, personal watercraft, motorcycles, power generators, etc., to provide electrical power generation for the power equipment. The alternator assembly 10 includes a stator 12 defining a central opening 14. The stator 12 can be mounted on an engine 22, or other mechanical energy producing machine, and has stator windings 16. A rotor 18, which may be operably or integrally coupled with a flywheel into a common rotational apparatus, is co-axially aligned with the stator 12 and coupled to a crankshaft 20. The rotational apparatus is fixedly coupled with the crankshaft 20 such that rotational apparatus rotates at the same revolutions per minute (RPM) as the crankshaft 20. The flywheel evens out the rotation of the crankshaft 20 while the engine 22 is running. The additional mass of the flywheel is used by the internal-combustion engine 22 to operate in a more consistent manner. In addition, one or more fan blades may be disposed on the rotational apparatus. By combining the flywheel and rotor 18 into one apparatus, the number of parts can be reduced and the amount of space required for the engine 22 and alternator assembly 10 can be reduced. The rotational apparatus induces a magnetic field within the stator 12 causing a current to be generated in the stator 12 to form a motor/generator.

Referring to FIG. 2, various components of the internal combustion engine 22 and a control system are schematically illustrated according to various aspects of the present disclosure. The engine 22 has at least one cylinder 24. A piston 26 and a spark plug 28 are each positioned at least partially within the cylinder 24. An intake valve 30 is arranged in an intake port 32, which opens into an upper portion of the cylinder 24. The intake port 32 is communicated with the atmosphere via an intake pipe 34, which may also be fluidly coupled with an air cleaner 36. A throttle valve 38 is arranged in the intake pipe 34. A fuel injection valve 40 is arranged in the intake pipe 34 upstream of the throttle valve 38. The fuel injection valve 40 injects fuel into the intake pipe 34 at a location upstream of the throttle valve 38.

The rotor 18 is configured to be fixedly coupled with the crankshaft 20 and is magnetically coupled with the stator 12. The stator 12 includes one or more windings 16 or coils of wire for magnetic flux coupling with the rotor 18 as the rotor 18 rotates with the crankshaft 20. The windings 16 of wire are electrically connected to a regulator 42 for rectifying, smoothing and stabilizing output voltage or current from the stator 12. In other embodiments, other orientations of the stator 12 and rotor 18 are possible. For example, the rotor 18 may rotate within the stator 12, or the rotor 18 may be adjacent to the stator 12.

A fuel pump 50 is arranged above the cylinder 24 for pressurizing fuel to be supplied to the fuel injection valve 40. A cam 48 also may be included for driving the fuel pump 50. The fuel pump 50 is connected to a fuel tank 54 via a conduit 52, and also to the fuel injection valve 40 and a pressure regulator 60 via a conduit 58. Connected to the regulator are the conduit 58 and a conduit 62 connected to the fuel tank 54. A fuel filter 56 is disposed in the fuel tank 54 such that it covers an open end of the conduit 52 which opens into the fuel tank 54. Fuel in the fuel tank 54 is supplied to the fuel pump 50 via the fuel filter 56 and the conduit 52. Pressurized fuel from the fuel pump 50 then is supplied via the conduit 58 to the fuel injection valve 40.

A sensor, such as a Hall Effect sensor 44, is positioned on the stator 12 and is in magnetic communication with the rotor 18. The Hall Effect sensor 44 may also be electrically coupled with the regulator 42. The regulator 42 can further be electrically coupled with a controller 46 that includes an oscillator. As the crankshaft 20 is connected to the rotor 18, the controller 46 is configured to determine a crankshaft position by receiving signals from the Hall Effect sensor 44 and to generate inputs to operate one or more components of the engine 22 based on a computed crankshaft position. Computation is provided by an integrated circuit of the controller 46 which accepts the oscillator's output and determines the crankshaft position by reading the outputs of the Hall Effect sensor 44, decodes these signals, and provides appropriate logic input to operate various components of the engine 22. For example, in response to receiving the crankshaft position, the controller 46 controls the timing for opening the fuel injection valve 40 and the duration over which the fuel injection valve 40 is opened by generating a signal for driving the fuel injection valve 40 to open, thereby allowing fuel to be injected into the intake pipe 34. The injection timing may be based on the piston location, which is fixedly attached to the crankshaft 20. By utilizing a sensor, such as the one described herein, the engine 22 can be provided with a rich fuel and air mixture that is injected into each combustion chamber of the engine 22 thereby improving combustion within each combustion chamber. In addition, by utilizing the positional data provided by the Hall Effect sensor 44, precisely controlled injection of fuel into each chamber can reduce fuel consumption, reduce exhaust emissions, create a simple adjustment of fuel injection timing, improve injection timing to reduce introduction of fuel into cylinder exhaust scavenge gas, which utilizes crankcase air flow controlled by a main throttle valve 38 to provide a source of inducted air for combustion in the combustion chamber, be adapted to various existing engine designs with minimal modifications, or improve run quality and starting of the engine 22.

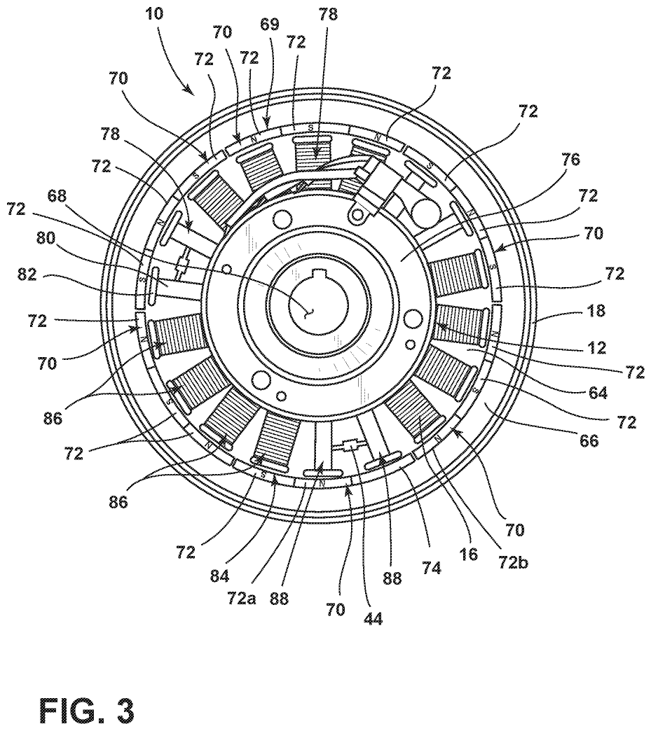

Referring to FIG. 3, the rotor 18 may be formed as a single piece having a circular hub 64 and a cylindrical shell 66 extending outwardly from one side of the hub 64. The hub 64 can include an opening 68 extending through the center thereof for mounting the rotor 18 on the crankshaft 20. The opening 68 can be keyed to ensure for preset mounting on the crankshaft 20. Magnetic segments 70 can be attached to an inner sidewall 69 of the shell 66 with adhesives and/or mechanically secured in place with a plurality of fasteners/spacers, a retaining ring, and/or any other retaining device. In embodiments having spacers, the spacers may be positioned between the magnetic segments 70 and can be held in place in the shell 66 of the rotor 18 by the fasteners. The spacers may be made of any type of non-magnetic material that can absorb the heat of the internal combustion engine 22.

The magnetic segments 70 are fixed to the inside surface of the sidewall 69 of the rotor 18 at substantially equally spaced angular intervals about the rotor 18. Each magnetic segment 70 is magnetized in a circumferential direction with periodic polarities. In the embodiment illustrated in FIG. 3, the rotor 18 includes six magnetic segments 70 disposed about the shell 66. Each magnetic segment 70 may include one or more portions 72 of various polarities. In some embodiments, such as the example illustrated in FIG. 3, adjacent portions 72 of various magnetic segments 70 may generally have opposing north-south polarities, which is generally indicated by “N” or “S” in FIG. 3. In other embodiments, the rotor 18 may include any other number (i.e., one or more) of magnetic segments 70 having any portions 72 of various polarities.

In some instances, one or more of the magnetic segments 70 may include a datum section 74 that has varied characteristics from the remaining portions 72 of the respective magnetic segment 70 or surrounding magnetic segments 70. The magnetic flux generated by the rotation of the rotor 18 relative the stator 12 generates an altered pulse as measured by the Hall Effect sensor 44 when the datum section 74 passes the Hall Effect sensor 44 compared to each remaining portion 72 of the plurality of magnetic segments 70. For example, the varied characteristic may be that the datum section 74 has a thickness (in any direction, including a circumferential or a radial direction) that is different from that of the remaining portions 72 of the plurality of magnetic segments 70 thereby altering the magnetic characteristics of the datum section 74 relative the remaining portions 72. Additionally or alternatively, the datum section 74 may be formed from a material having different or varied magnetic properties including different elemental compositions. Additionally or alternatively, the datum section 74 may have reduced or increased magnetic flux density (or other detectable property) when compared to one or more of the remaining portions 72. In some embodiments, the polarity of each adjacent portion 72 to the datum section 74 may be of a common polarity. For example, as illustrated in FIG. 3, an intermediate portion 72a of the magnetic segment 70 adjacent to the datum section 74 has a first polarity (e.g., positive) and an end portion 72b of the adjacent magnetic segment 70 to the datum section 74 also has the first polarity (e.g. positive). In other embodiments, however, the two adjacent portions 72 to the datum section 74 may have varied polarities or various magnitudes of magnetic flux. In still other aspects, both the datum section and each of its adjacent portions 72 may have the same magnetic flux. In yet another aspect, either the datum section 74 or one or both of the adjacent portions 72 may be a non-magnetized portion. Each of the examples discussed above may reflect the property that the datum section 74 signifies a change in the pattern of magnetic flux that exists about a remainder of the rotor 18.

As the datum section 74 has varied magnetic characteristics, the output current of the alternator assembly 10 may be altered as compared to each portion 72 having a common characteristic as measured by the sensor, which can be a Hall Effect sensor 44. Accordingly, in embodiments using six magnetic segments 70 each having three portions 72, the altering of the characteristics for one portion 72 may minimize this effect by altering the characteristics of just 1/18 or 5.6% of the magnetic portions 72. As more magnetic segments 70 or portions 72 are disposed about the rotor 18, this percentage may be even further decreased leading to less alteration from the original output of the alternator assembly 10 while still producing a detectable datum point. In such instances, a pulse rate may be adjusted to account for and provide accurate data as to the position of the crankshaft 20.

In some embodiments, the magnetic materials used to form the magnetic segments 70 may include magnetic composites, such as neodymium-iron-boron (NdFeB), ceramic, neodymium, samarium-cobalt, alnico, a combination thereof, or any other practicable material. As used herein, the term “magnetic composite” may be defined as nay ferrous powder metal material that can be molded into a component. In some cases, the magnetic composite may be formed into the component using a high-pressure compaction process. In accordance with some embodiments, the magnetic composite may include a ferromagnetic material and a polymer coating. In still other embodiments, the magnetic composite may include an insulating material disposed over a ferromagnetic material or serving as a matrix within which a ferromagnetic material is disposed.

In various embodiments, in order to provide materials having varying magnetic properties, the datum section 74 and the remaining portions 72 may comprise different magnetic materials including different elemental compositions. For example, the datum section 74 may include a ferromagnetic material and a first type of insulating material, while the remaining portions 72 may include the ferromagnetic material and a second type of insulating material. Alternatively, in some embodiments, the datum may include a first type of ferromagnetic material and a first insulating material, and the remaining portions 72 may include a second type of ferromagnetic material and the first insulating material or a second insulating material. In other embodiments, the first and second magnetic materials respectively forming the datum section 74 and the remaining portions 72 may comprise substantially identical elemental compositions; however, the constituents of the compositions may be present at different weight percentages. For example, the first magnetic material may include, by volume, about 6.0% to about 6.5% of the insulating material, while the second magnetic material may include, by volume, about 4.0% to about 5.0% of the insulating material. In other embodiments, percentage ranges may be more or less than the aforementioned ranges. In still other embodiments, the first magnetic material and the second magnetic material may each comprise ferromagnetic materials that are coated with an insulating material, and a thickness of the insulating material may differ for each of the first and second magnetic materials.

With further reference to FIG. 3, the stator 12 has a central core 76 with a plurality of poles 78 extending outwardly from and circumferentially arranged around the central core 76. The poles 78 can be spaced-apart with the same polar pitch as the magnetic segments 70. The poles 78 each have a radially extending member 80, extending outwardly from the central core 76 and an end member 82 located at the end of the radially extending member 80. Each end member 82 can have a width larger than a width of the radially extending member 80. The windings 16 are wound around one or more of the radially extending members 80. An air gap 84 exists between the end members 82 and the magnetic segments 70 to allow rotation of the rotor 18 around the stator 12.

With further reference to FIG. 3, in some embodiments, the stator 12 may include windings 16 around various stator poles 78 while remaining stator poles 78 may be free of windings 16. Accordingly, various groups 86 of poles 78 having respective windings 16 on each pole 78 may be separated by one or more sets of blank poles 78. For example, as illustrated in FIG. 3, the stator 12 includes first, second, and third groups 86 of four poles 78 each having windings 16 on each pole 78. Each group 86 of poles 78 can be separated by a set 88, or pair, of blank poles 78. In some embodiments, every third winding is coupled with one another, which allows the alternator to produce a single-phase alternating current output signal, although persons skilled in the art will appreciate that various other configurations may be utilized without departing from the scope of the present disclosure. If the desired device is a three-phase device, however, the total number of windings 16 should be divisible by three in order to maintain proper phase alignment. In various embodiments, each of the stator poles 78 may include a winding thereon. Or, the stator 12 may have any number of groups 86 including windings 16 thereon that are separated by any number of blank poles 78.

Some sensors may function with increased accuracy when isolated. Accordingly, in some embodiments, the Hall Effect sensor 44 is disposed on or extends between a set 88 having one or more blank poles 78, as illustrated in FIG. 3 to isolate the Hall Effect sensor 44 from the windings 16 leading to more accurate readings and/or signals. As provided herein, the sensor may be configured as a Hall Effect sensor 44. The magnetic segments 70, and portions 72 thereof, generally have alternating north and south magnetic poles, which can be detected by the Hall Effect sensor 44, in addition to the magnitude of the polarity.

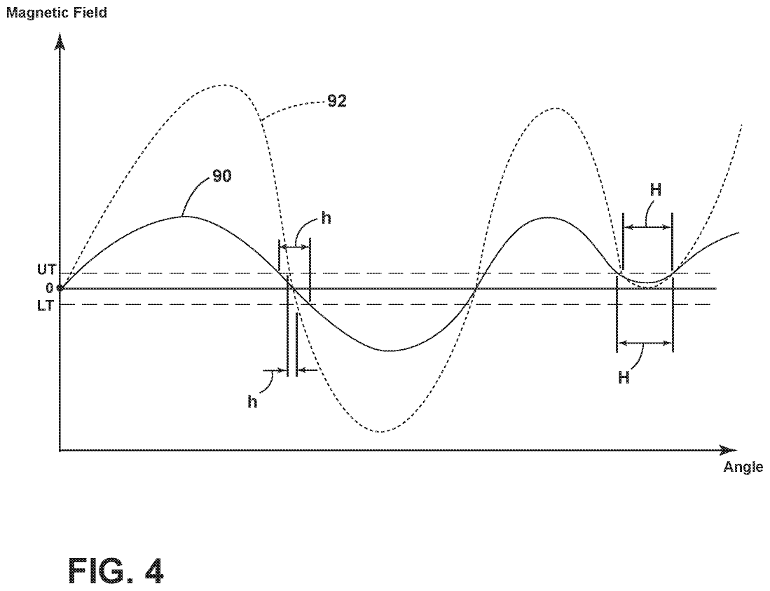

As illustrated in FIG. 4, the Hall Effect sensor 44 output signal generally oscillates between the high state and the low state as the various portions 72 of the magnetic segments 70, having generally alternating polarities, pass the Hall Effect sensor 44. The output signal can be a current signal substantially proportional to the magnetic field sensed by the Hall Effect sensor 44. However, it should be understood that this is not intended as a limitation of the present disclosure. Depending on the circuitry coupled to Hall Effect sensor 44, the output signal can be either a current signal or a voltage signal and can have any kind of relation with the magnetic field sensed by the Hall Effect sensor 44. The Hall Effect sensor 44 can be connected to the regulator 42 and the controller 46 for amplification, filtering, interpolation algorithms, etc.

The Hall Effect sensor 44 is configured to generate an output signal to the controller 46, which assumes a first state, such as a high state when the magnetic field is greater than a predetermined positive threshold UT. Conversely, the logic output of the Hall Effect generates a second state, such as a low state, if the magnetic field falls below a predetermined negative threshold LT. During rotation of the rotor 18, the amplitude of the magnetic field, which acts on the Hall Effect sensor 44, varies sinusoidally at a frequency dependent on the RPM of the rotor 18 (and consequently, the crankshaft 20), the characteristics and properties of the magnetic segments 70, and the distance the Hall Effect sensor 44 is placed from the rotor 18.

Due to the magnetization process, there is a degree of blurring as the magnetic polarity changes from North to South (and vice versa), so the change waveforms 90, 92 can be more sinusoidal, rather than square. This means the switching point moves to the right (delayed) on the illustrated graph as the thresholds increase in amplitude (i.e., from line 90 to line 92). Additionally, flux density from one magnetic segment 70 can also vary from that of adjacent segments 70, as will the effects of temperature and the width of the gap 84 (FIG. 3) between the Hall Effect sensor 44 and the magnetic segments 70. To accommodate for these variations, multiple switching point effects can be minimized by creating an elongated position on the flux waveform 90, 92 due to the datum section 74 (FIG. 3) in which the magnetic field passing through the Hall Effect sensor 44 may be of one polarity, approach neutral, and then increase in the same polarity. Thus, the variation of the magnetic field as a function of the rotation angle is no longer sinusoidal as shown in FIG. 4 when the Hall Effect sensor 44 outputs magnetic flux from the datum section 74. In other words, the rising and falling edges of the field created by the ring are angularly spaced. More particularly, in the case of a rotor 18 having the datum section 74 provided herein, these field changes are due to variations in the characteristics of the datum section 74 relative to the remaining portions 72 of the magnetic segments 70 depending on whether the datum section 74 or a remaining portion 72 of the magnetic segments 70 is located in front of the Hall Effect sensor 44. The modified behavior of the detector is shown in FIG. 4, where H denotes the hysteresis increased (compared with the low hysteresis h of current sensors) thereby providing a more accurate prediction of the crankshaft position. With higher precision in crankshaft position, emission issues can be minimized. Such data may also allow for the removal of a secondary toothed outer ring and a variable reluctance sensor, or any other sensor, for detecting a timing of the fuel injection into the chamber.

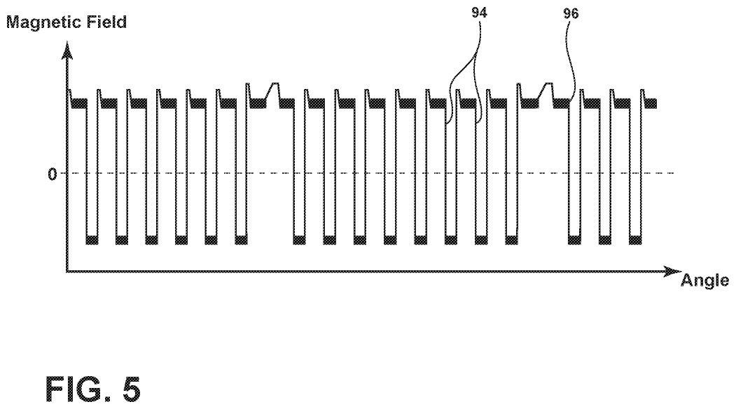

Referring to FIG. 5, due to the datum section 74 (FIG. 3) having varied characteristics from the remaining portions 72 of the magnetic segments 70, a missing pulse or a detectable datum signal relative to the periodic pattern of the remaining magnetic portions 72 is provided as the datum section 74 passes the Hall Effect sensor 44. The signal generated by the datum section 74 identifies the angular position of the crankshaft 20 (FIG. 1). For example, as graphically illustrated in FIG. 5, a plurality of pulses 94 provided by the noted periodic pattern are substantially similar to one another and a missing pulse 96 corresponds to the datum section 74. Due to the missing pulse, the crankshaft position may be known and monitored. As provided herein, the fuel may be injected into the chamber at an appropriate time based on the position of the crankshaft, thereby reducing the emissions produced during operation of the internal combustion engine 22.

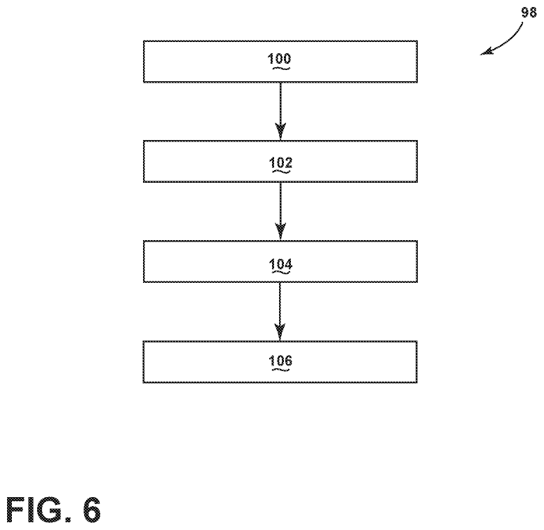

Referring to FIG. 6, a method 98 of assembling the alternator assembly, such as the alternator assembly 10 illustrated in FIG. 3, is schematically illustrated, according to some embodiments. The method begins at step 100 wherein the rotor, such as the rotor 18 illustrated in FIG. 3, is formed, which can be accomplished by using a variety of methods, such as, for example, die casting, sand casting, plaster molding, metal injection molding, etc. The rotor can be formed as a single, integral unit that includes the hub and the shell, although the rotor can be formed of various pieces joined together to create an integral unit. As used herein, “integrally formed” means formed as a single unit out of a unitary piece of material, such as by molding. An example method of making the rotor may generally include: (1) providing a mold made of known materials such as sand or plaster; (2) introducing a molten material into the mold; (3) allowing the molten material to harden a predetermined amount of time to form the molded unit; (4) stripping the molded unit from the mold; and (5) performing various finishing processes such as cleaning, trimming, machining, and/or balancing the molded unit. Other methods of forming the rotor can also be used without departing from the scope of the present disclosure.

In various embodiments, the rotor may be integrally formed with a flywheel or later attached thereto. In embodiments in which the flywheel is later attached to the rotor, any practicable attachment assembly may be used for coupling the components with one another. For example, the rotor and the flywheel may be coupled to one another through fasteners, weldment, and so on.

The rotor and flywheel may be made of a variety of materials, which may be generally non-magnetized. In various embodiments, the rotor may be made of any castable metal, such as, for example, iron, aluminum, zinc, magnesium, etc. Other materials may also be used depending on the desired use for the rotor.

At step 102, non-magnetized segments are coupled to the rotor with an adhesive and/or are mechanically secured in place. In one instance, for example, the segments may be coupled using an epoxy, particularly a high temperature-resistant epoxy, such as the one sold under the trademark 9340 HYSOL, by Loctite. The segments may also be coupled to the rotor by welding, staking, through use of a retaining ring, or the like. The non-magnetized permanent magnetic segments are arranged around the rotor shell, as provided herein, to form an annular array. In some embodiments, the permanent magnetic segments of the rotor can form a Halbach array (i.e. obtained by Halbach magnetization) to produce an essentially sinusoidal shaped flux distribution with low harmonic content within an electrical machine. This reduces alternating current (AC) harmonic losses, torque ripple, vibration, and acoustic noise.

At step 104, a magnetizing fixture is utilized for magnetization of multiple non-magnetized permanent magnetic segments of the rotor. The magnetization fixture can include multiple magnetization coils wound around a magnetizing yoke. Generally, the number of magnetizing coils chosen is equal to the number of magnetic segments of the rotor. Accordingly, in some embodiments, the magnetization fixture can include seventeen magnetizing coils and a non-magnetized segment that aligns with the datum section, such as the datum section 74 illustrated in one example in FIG. 3. In some embodiments, an eighteenth coil may align with the datum section and have varied magnetizing abilities/characteristics form the remaining coils. The magnetizing coils are suitably arranged in a magnetizing circuit and energized by a power source provided in the magnetizing circuit.

In operation, the rotor is positioned within a magnetizing fixture of a magnetizer system and magnetization directions of the permanent magnetic segments are aligned with the calculated direction of flux from the magnetizing fixture. The magnetizing coils are then energized by the power source. This power source may be tuned to the magnetizing fixture so that the internal impedance of the source under load approximately matches the impedance of the magnetizing fixture. This allows for the maximum utilization of the energy transfer capability of the power source. Once the permanent magnetic segments are magnetized, the rotor is removed from the magnetizing fixture and is assembled within the stator, such as the stator 12 illustrated in FIG. 3. The present technique may facilitate magnetization of an electrical machine rotor in a one-step process, thus obviating the need to assemble the rotor from pre-magnetized segments, which may be cumbersome and difficult as discussed earlier. The resulting magnetized rotor produces an improved sinusoidal shaped flux distribution within the alternator while simultaneously forming the datum section.

At step 106, a sensor is operably coupled to a stator and the stator is positioned within the rotor. The sensor is configured to detect a datum section as the datum section of the magnetic segments passes the sensor. In some embodiments, the sensor is configured as a Hall Effect sensor that is supported on two opposing sides by blank stator poles that are free of windings. By placing the Hall Effect sensor between two blank stator poles, the Hall Effect sensor may be further isolated from any proximately disposed windings thereby allowing for a better measurement of the magnetic flux of the various portions of the magnetic segments as well as the datum section. The Hall Effect sensor can be configured to generate signals based on the magnitude and polarity of magnetic flux generated by each portion of the plurality of magnetic segments. Other types of sensors, which may be wound about a single pole, and/or formed from a coil of wire about a pole may not be capable of generating all of the data with similar accuracy as the sensor provided herein. For example, other types of examples may be less effective at detecting a polarity and/or the magnetic flux generated based on the proximity to other stator poles. Moreover, other types of sensors may be less effective at differentiating between the polarities of the various segments than the Hall Effect sensor of the alternator assembly described herein.

The system of the present disclosure provides many advantages over currently available electronic systems. For example, the use of the Hall Effect sensor between two blank poles of the stator may allow for the removal of locating teeth on the rotor. The removal of the teeth reduces the manufacturing cost of the alternator assembly. Moreover, the electronic system provided herein may alter a single portion of a magnetic segment thereby forming a datum section. The datum section may be a minimal disturbance in the flux of the system thereby reducing the effect of adding the datum section to the rotor. The system of the present disclosure can also be manufactured in a compact, relatively inexpensive assembly, of relatively simple design and economical manufacture that can be readily adaptable to a wide range of engine applications, while maintaining durability requiring little maintenance, and having a long useful life.

It will be appreciated by those skilled in the art that while the invention has been described above in connection with particular embodiments and examples, the invention is not necessarily so limited, and that numerous other embodiments, examples, uses, modifications, and departures from the embodiments, examples, and uses are intended to be encompassed by the present disclosure and claims. The entire disclosure of each patent and publication cited herein is incorporated by reference, as if each such patent or publication were individually incorporated by reference herein.

We claim:

1. An alternator assembly comprising:
a crankshaft rotatable about an axis;
a rotor coupled with the crankshaft and rotatable about the axis in conjunction with the crankshaft, the rotor defining a hub and a cylindrical shell extending outwardly from one end of the hub;
a plurality of magnetic segments disposed circumferentially about an interior surface of the shell, wherein each of the plurality of magnetic segments includes one or more portions having one of a north or south polarity and at least one of the portions on one of the plurality of magnetic segments configured as a datum section, the datum section having a varied characteristic from remaining one or more portions of the plurality of magnetic segments;
a stator separated from the rotor by a gap and including a plurality of stator poles, wherein the plurality of stator poles includes first and second groups of poles each having respective windings on each pole within the first and second group, the first and second groups separated by a pair blank poles; and
a Hall Effect sensor extending between and supported by the pair of blank poles, the Hall Effect sensor configured to generate signals based on a magnitude and a polarity of magnetic flux generated by each portion of the plurality of magnetic segments.

2. The alternator assembly of claim 1, wherein the Hall Effect sensor is operably coupled with a regulator, the regulator further configured to accept current generated by rotation of the rotor relative the stator.

3. The alternator assembly of claim 1, wherein the plurality of magnetic segments includes six magnetic segments and the six magnetic segments are disposed at equal distances about the crankshaft.

4. The alternator assembly of claim 1, wherein the varied characteristic is configured as a variance in a thickness of the datum section from that of remaining portions of the plurality of magnetic segments thereby altering a magnetic property of the datum section relative the remaining portions.

5. The alternator assembly of claim 1, wherein the datum section is formed from a material having different or varied magnetic properties including different elemental compositions thereby creating the varied characteristic.

6. The alternator assembly of claim 1, wherein the datum section has reduced flux density compared to one or more of remaining portions thereby creating the varied characteristic.

7. The alternator assembly of claim 1, wherein a polarity of each adjacent portion to the datum section may be of a common polarity.

8. The alternator assembly of claim 1, wherein the magnetic flux generated by the rotation of the rotor relative the stator generates an altered pulse as measured by the Hall Effect sensor when the datum section passes the Hall Effect sensor compared to each remaining portion of the plurality of magnetic segments.

9. The alternator assembly of claim 8, wherein the altered pulse is indicative of a crankshaft position and in response to receiving the crankshaft position, a controller controls an opening of a fuel injection valve and a duration over which the fuel injection valve.

10. An alternator assembly comprising:
a rotor rotatably coupled with a crankshaft about a common axis;
a first magnetic segment positioned on the rotor and including at least a first portion and a datum section separated from the first portion, the first portion having one of a north or south polarity and the datum section having varied characteristic from the first portion;
a stator separated from the rotor by a gap and including a plurality of stator poles, wherein the plurality of stator poles include first and second poles each having respective windings thereabout, the first and second stator poles separated by a pair blank stator poles; and
a Hall Effect sensor extending between and supported by the blank poles, the Hall Effect sensor configured to generate signals based on a polarity of magnetic flux generated by at least one of the first portion and the datum section.

11. The alternator assembly of claim 10, wherein the rotor is integrally formed with a flywheel that is fixedly coupled with the crankshaft.

12. The alternator assembly of claim 10, further comprising:
a second magnetic segment position on an opposite side of the datum section from the first portion of the first magnetic segment and having at least a second portion adjacent to the datum section, the first portion and the second portion having a common polarity.

13. The alternator assembly of claim 10, further comprising:
a regulator electrically coupled with the stator and a controller, wherein the controller includes an oscillator and the controller is configured to determine a crankshaft position by receiving signals from the Hall Effect sensor and to generate inputs to operate one or more components of an engine.

14. The alternator assembly of claim 10, wherein the varied characteristic is configured as a variance in a thickness of the datum section from that of remaining portions of the first magnetic segment thereby altering a magnetic property of the datum section relative the remaining portions.

15. The alternator assembly of claim 10, wherein the datum section has reduced flux density compared to one or more of the remaining portions thereby creating the varied characteristic.

16. A method of manufacturing an alternator assembly, the method comprising:
forming a rotor having a hub and a shell;
assembling one or more non-magnetized segments to the rotor;
determining a plurality of magnetization orientation directions of the non-magnetized magnet portions and a varied characteristic for a datum section;
positioning the rotor within a magnetizing fixture and aligning magnetization directions of the magnet portions with a calculated direction of flux from the magnetizing fixture, wherein the datum section is aligned with a datum portion of the magnetizing fixture; and
energizing the magnetizing coils a power source.

17. The method of claim 16, wherein the step of energizing the magnetizing coils a power source comprises an electrical connection of the power source to the magnetization fixture for a predetermined amount of time.

18. The method of claim 16, wherein the magnetization orientation directions of the permanent magnet portions are generally aligned with a direction of flux produced by the magnetizing fixture.

19. The method of claim 16, wherein the assembling one or more non-magnetized segments to the rotor step comprises assembling the non-magnetized permanent magnetic segments in an annular pattern on a rotor shell prior to positioning the non-magnetized permanent magnetic segments in the magnetization fixture.

20. The method of claim 16, wherein the magnetizing fixture comprises a plurality of coils wound around a core, the coils being equal in number to a number of poles of the rotor.
